(19) United States
(12) Patent Application Publication
(10) Pub. No.: US 2025/0253458 A1
(43) Pub. Date: Aug. 7, 2025

(54) BATTERY HOLDER

(71) Applicant: LOTES CO., LTD, Keelung (TW)

(72) Inventors: Guang-Guang Zhang, Guangzhou (CN); Pei-Yu Lou, Guangzhou (CN); Yong Liu, Guangzhou (CN)

(21) Appl. No.: 19/027,300

(22) Filed: Jan. 17, 2025

(30) Foreign Application Priority Data
Feb. 3, 2024 (CN) 202410152620.0
Sep. 2, 2024 (CN) 202411223138.8

(51) Int. Cl. H01M 50/202; H01M 50/109; H01M 50/271; H01M 50/59

(52) U.S. Cl. CPC H01M 50/202; H01M 50/109; H01M 50/271; H01M 50/59

(57) ABSTRACT

A battery holder includes a base body accommodating a battery and a cover covering the base body. One side of the base portion of the cover is provided with a limiting structure to be limited with the base body, and two elastic arms, two latching sections and an auxiliary portion located between the two elastic arms extend from another side thereof. The two latching sections engage with two locking portions of the base body to fix the cover. A surrounding wall of the base body and the auxiliary portion collectively shield a side surface of the battery, and a base portion and the elastic arms collectively shield an upper surface of the battery, thereby shielding and protecting the battery.

### CROSS-REFERENCE TO RELATED PATENT APPLICATION

This non-provisional application claims priority to and the benefit of, pursuant to 35 U.S.C. § 119(a), patent application Serial No. CN202410152620.0 filed in China on Feb. 3, 2024, and patent application Serial No. CN202411223138.8 filed in China on Sep. 2, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a battery holder, and particularly to a battery holder having a cover.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A battery being used as a power source in various electrical devices has become a very common phenomenon, and children often come into contact with many of these electrical devices in their daily lives. Currently, a battery holder used in one type of electrical device includes a base body and a battery. A bottom wall of the base body and surrounding walls extending upward from edges of the bottom wall collectively form an accommodating cavity to accommodate the battery. One side of the surrounding wall forms a groove running therethrough, allowing a human being to reach into the accommodating cavity from the groove to take out the battery by hand, without the need for specialized tools, thereby making it easy to detach and replace the battery. To fix the battery, a plurality of protruding blocks are usually provided on inner surfaces of two opposite sides of the surrounding wall, and the protruding blocks are located above a top edge of the battery to stop the battery from moving upward and preventing the battery from falling out of the accommodating cavity. However, such a structure leaves the upper surface and the side surface of the battery exposed in the base body, thus making it easy for children to notice the battery and directly insert their fingers into the accommodating cavity to take out the battery, which may lead to accidental ingestion of the battery by children. In addition, the battery is at risk of falling out of the accommodating cavity in an environment with prolonged vibrations.

Therefore, a heretofore unaddressed need to design an improved battery holder exists in the art to address the aforementioned deficiencies and inadequacies.

### SUMMARY

In view of the issues in the background, the present invention is directed to a battery holder, in which a cover is assembled on a base body to collectively shield a battery. The cover is provided with elastic arms and an auxiliary portion. Two latching sections deflect to be close toward each other and are simultaneously locked downward to the two locking portions of the base body, thus fixing the cover to the base body along an up-down direction. A base portion of the cover and the two elastic arms collectively shield an upper surface of the battery, and the auxiliary portion shields a side surface of the battery exposed in the groove of the base body, such that the children do not easily notice the battery, thus preventing the children from reaching into the accommodating cavity from the top of the accommodating cavity or from the groove and easily taking out the battery. By such design, when the cover is open, a human hand may directly take out the battery from the groove, and when the cover is closed, the groove is shielded by the auxiliary portion, thus preventing the children from improperly touching the battery therein and thereby preventing from affecting the electrical connection between the battery and the positive elastic sheet as well as the negative elastic sheet. The two elastic arms extend along the front-rear direction, and the two latching sections extend along the up-down direction, such that the elastic arms and the latching sections collectively form long moment arm structures with good elasticity for easy locking. The auxiliary portion has elasticity and is located between the two latching sections. In the mounting process of the cover, when mounting tolerances exist to cause the two latching sections to excessively deflect, the latching sections may abut against the auxiliary portion, and the auxiliary portion, which is elastic, deflects together with the latching sections to provide a soft cushioning effect, thus preventing an excessive interference force between the latching sections and the auxiliary portion that causes damages. The elastic auxiliary portion in turn provides a sufficient force to correct the positions of the two latching sections, thus ensuring the two latching sections to be normally locked to the two locking portions, preventing excessive deformation and damage to the two latching sections, ensuring the structural strength of the two latching sections, increasing the usage life of the battery holder, and reducing the tolerance and dimension requirements of the latching sections, which is conducive to reducing the manufacturing cost of the battery holder.

To achieve the foregoing objective, the present invention adopts the following technical solutions. A battery holder is used to accommodate a battery. The battery holder includes: a base body, having a bottom wall and a surrounding wall extending upward from the bottom wall, wherein the bottom wall and the surrounding wall collectively form an accommodating cavity to accommodate the battery, a side of the surrounding wall is provided with a groove running therethrough, a side wall of the battery is exposed to the groove, and the base body is provided with a locking portion at each of two opposite sides of the groove; a positive elastic sheet and a negative elastic sheet, respectively accommodated in the base body and electrically connected to the battery, wherein the negative elastic sheet is exposed in the groove; and a cover, having a base portion, wherein a limiting structure extends from one side of the base portion to be detachably assembled to the base body, two elastic arms and an auxiliary portion located between the two elastic arms extend from another side of the base portion along a front-rear direction, a latching section extends downward from a side of each of the elastic arms away from the base portion, each of the latching sections engages with the corresponding locking portion along an up-down direction, and the auxiliary portion extends downward to be between the two latching sections; wherein when the battery is installed in the accommodating cavity, the base portion and the two elastic arms collectively shield an upper surface of the battery, the two elastic arms are pressed to move altogether downward, the two latching sections deflect toward each other and lock downward to the two locking portions to fix the cover to the base body along the up-down direction, the auxiliary portion shields the groove, and the auxiliary portion and the surrounding wall collectively shield the side surface of the battery.

In certain embodiments, another side of the base body opposite to the base body is provided with a positioning block, each of two sides of the positioning block is protrudingly provided with a pivot along a left-right direction, in the left-right direction, the two pivots are respectively located at two sides of the positive elastic sheet, the limiting structure comprises a limiting slot concavely provided from the one side of the base portion and two rotating portions protrudingly provided from two sides of the limiting slot respectively, and when the rotating portions of the cover rotate downward around the pivots of the base body such that the cover covers a top portion of the base body, the pivots stop the rotating portions of the cover from moving upward, and the limiting slot of the cover and the positioning block of the base body match with each other to limit the cover in the left-right direction.

In certain embodiments, an inner surface of the surrounding wall is protrudingly provided with a plurality of stopping portions to stop the upper surface of the battery, and a stopping area of a corresponding one of the stopping portions closest to the pivots is greater than a stopping area of each of others of the stopping portions.

In certain embodiments, each of the positive elastic sheet and the negative elastic sheet has a fixing portion fixedly mounted on the base body and at least one contact portion extending from one side of the fixing portion into the accommodating cavity to be electrically connected to the battery, the contact portion of the positive elastic sheet and the contact portion of the negative elastic sheet elastically abut upward against the battery, the contact portion of the positive elastic sheet is higher than the contact portion of the negative elastic sheet, and the corresponding one of the stopping portions closest to the pivots is located above the contact portion of the positive elastic sheet and abuts downward against the battery.

In certain embodiments, two reserved notches are concavely provided downward at locations adjacent to the groove from an upper surface of the surrounding wall, in a left-right direction, the two reserved notches are respectively located at the two sides of the groove and in communication with the groove, the base body is provided with two mounting portions protruding outward at the two sides of the groove, the locking portion is formed by protruding from a side edge of each of the mounting portions away from the groove, one side of each of the two mounting portions closer to the groove is concavely provided with a retaining slot to retain two side edges of the negative elastic sheet, a middle portion of the negative elastic sheet is located in the groove, and the two elastic arms respectively pass through the corresponding reserved notches and are partially located at upper sides of the corresponding mounting portions.

In certain embodiments, one side of each of the elastic arms away from the base portion is provided with an operational portion and a through hole running through the operational portion along the up-down direction, each of the latching sections comprises an extending portion extending downward from a corresponding one of the elastic arms and a buckling portion provided on the extending portion to lock to the locking portion, one of the buckling portion and the locking portion is an engaging slot, the other of the buckling portion and the locking portion is an engaging block, and each of the engaging blocks is exposed in the corresponding one of the through holes in the up-down direction.

In certain embodiments, the base portion and the auxiliary portion are both provided with a plurality of heat dissipation holes running downward therethrough, the battery is exposed in the heat dissipation holes, and a diameter of each of the heat dissipation holes is less than a minimum distance between the two elastic arms.

In certain embodiments, a lower surface of the base portion is protrudingly provided with a plurality of reinforcing ribs, a gap exists between a lower surface of each of the reinforcing ribs and the upper surface of the battery, at least one of the reinforcing ribs closest to the latching sections is further protrudingly provided with a protruding block along the up-down direction, and the protruding block is in contact with the battery.

In certain embodiments, the auxiliary portion is in a cantilever shape and has elasticity, the auxiliary portion comprises a first section extending from the base portion along the front-rear direction and provided at intervals with the two elastic arms, and a second section extending downward from one side of the first section away from the base portion, the first section shields the upper surface of the battery, and the second section enters the groove and shields the side surface of the battery exposed in the groove.

In certain embodiments, when the latching sections and the corresponding locking portions lock together along the up-down direction, a maximum distance between the second section and each of the two latching sections is less than a width of each of the latching sections.

In certain embodiments, a portion of the second section close to the battery is configured to shield the side surface of the battery, another portion of the second section is located between the two latching sections to stop the two latching sections from excessively deflecting toward each other, a minimum lateral width of the portion of the second section close to the battery is greater than or equal to a lateral width of the other portion of the second section, one side of the second section facing the battery forms a guiding curved surface, and the guiding curved surface guides the second section to cross over the battery above the battery and enters the groove.

In certain embodiments, an upper surface of the first section is flush with an upper surface of each of the elastic arms, a lower surface of the second section is flush with a lower surface of each of the latching sections or passes downward beyond the lower surface of each of the latching sections, the negative elastic sheet is located below the second section, and in the up-down direction, a gap exists between the lower surface of the second section and the negative elastic sheet.

In certain embodiments, a distance between the first section and each of the two elastic arms is less than or equal to a distance between the second section and each of the two latching sections.

In certain embodiments, another side of the surrounding wall opposite to the groove is provided with two clamping slots running therethrough, in a left-right direction, the two clamping slots are respectively located at two sides of the positive elastic sheet, the base portion is provided with an abutting portion protruding downward, the abutting portion extends downward to abut the battery, the positive elastic sheet has two contact portions protruding toward the accommodating cavity, the two contact portions are respectively located at two outer sides of extending lines of two side edges of the abutting portion, the limiting structure comprises two limiting blocks protrudingly provided from the one side of the base portion at an interval, and the two limiting blocks and the two clamping slots correspondingly engage and match to limit one side of the cover from moving upward.

In certain embodiments, the two latching sections are both located in the groove to collectively shield the side surface of the battery with the auxiliary portion, the base body is provided with two mounting portions protruding outward at the two sides of the groove, the two locking portions are concavely provided from sides of the two mounting portions facing each other respectively, a buckling portion is provided to protrude from one side of each of the two latching sections away from each other toward a direction away from each other, and the two buckling portions and the two locking portions lock together.

A battery holder is used to accommodate a battery. The battery holder includes: a base body, having a bottom wall and a surrounding wall extending upward from the bottom wall, wherein the bottom wall and the surrounding wall collectively form an accommodating cavity to accommodate the battery, a side of the surrounding wall is provided with a groove running therethrough, a side wall of the battery is exposed to the groove, and the base body is provided with a locking portion at each of two opposite sides of the groove; a positive elastic sheet and a negative elastic sheet, respectively accommodated in the base body and electrically connected to the battery, wherein the negative elastic sheet is exposed in the groove; and a cover, having a base portion, wherein a limiting structure extends from one side of the base portion to be detachably assembled to the base body, two elastic arms extend from another side of the base portion along a front-rear direction, a latching section extends downward from a side of each of the elastic arms away from the base portion, and each of the latching sections engages with the corresponding locking portion along an up-down direction; wherein an auxiliary portion is elastic and is provided between the two latching sections, and the auxiliary portion is capable of elastically deflecting to block the two latching sections from excessively deflecting; wherein when the battery is installed in the accommodating cavity, the base portion and the two elastic arms collectively shield an upper surface of the battery, the two elastic arms are pressed to move altogether downward, the two latching sections deflect toward each other and lock downward to the two locking portions to fix the cover to the base body along the up-down direction, and the auxiliary portion shields a portion of the side surface of the battery exposed in the groove.

In certain embodiments, the auxiliary portion is formed by integrally extending from the cover, the auxiliary portion comprises a first section extending from the base portion along the front-rear direction and located between the two elastic arms and a second section extending downward from the first section and located between the two latching sections, gaps exist between a left side and a right side of the second section and the two latching sections, and the first section and the second section collectively form a cantilever shape, such that the auxiliary portion is capable of elastically deflecting between the two latching sections.

In certain embodiments, a distance between the first section and each of the two elastic arms is less than or equal to a distance between the second section and each of the two latching sections.

In certain embodiments, a width of the second section is less than or equal to a width of the first section, and the width of the second section is less than or equal to a width of each of the latching sections.

In certain embodiments, an extending length of the auxiliary portion along the front-rear direction is equal to a length of each of the elastic arms.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of a battery holder according to a first embodiment of the present invention.

FIG. 2 is a perspective view of a battery holder according to the first embodiment of the present invention when the cover is flipped open.

FIG. 3 is a perspective view of a battery holder according to the first embodiment of the present invention when the cover is assembled.

FIG. 4 is a top view of a battery holder according to the first embodiment of the present invention.

FIG. 5 is a sectional view of FIG. 4 along the A-A direction.

FIG. 6 is a sectional view of FIG. 4 along the B-B direction.

FIG. 7 is a front view of a battery holder according to the first embodiment of the present invention.

FIG. 8 is a schematic view of a battery holder according to the first embodiment of the present invention, where the cover is 180 degrees inversed.

FIG. 9 is a perspective schematic view of a battery holder according to a second embodiment of the present invention.

FIG. 10 is a schematic view of a battery holder according to the second embodiment of the present invention before the battery is assembled in the base body.

FIG. 11 is a front view of a battery holder according to the second embodiment of the present invention.

FIG. 12 is a sectional view of FIG. 11 along the C-C direction.

FIG. 13 is a perspective schematic view of a battery holder according to a third embodiment of the present invention.

FIG. 14 is a schematic view of a battery holder according to the third embodiment of the present invention, before the cover is installed on the base body.

FIG. 15 is a top view of a battery holder according to the third embodiment of the present invention.

FIG. 16 is a sectional view of FIG. 15 along the D-D direction.

FIG. 17 is a sectional view of FIG. 15 along the E-E direction.

FIG. 18 is a front view of a battery holder according to the third embodiment of the present invention.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated. As used herein, the terms “comprising”, “including”, “carrying”, “having”, “containing”, “involving”, and the like are to be understood to be open-ended, i.e., to mean including but not limited to.

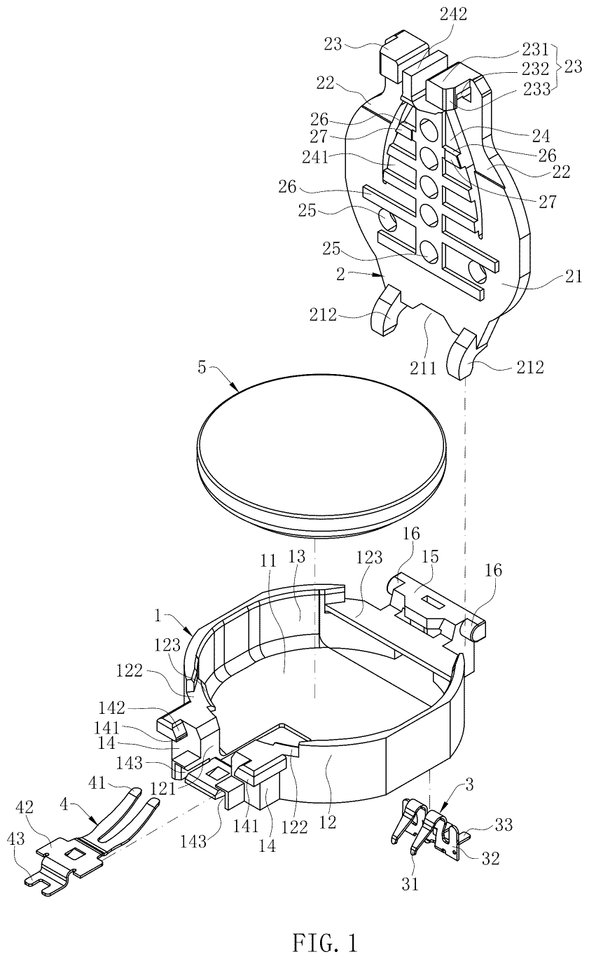

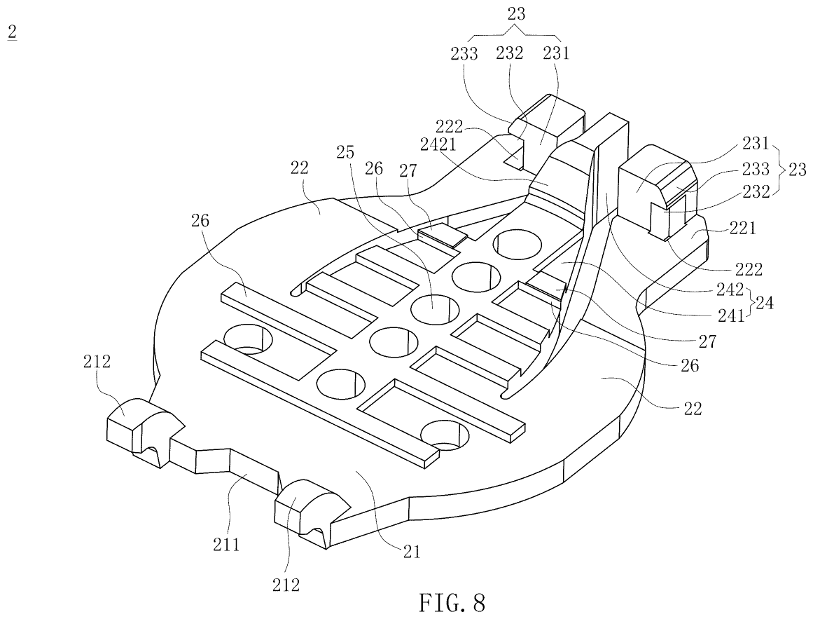

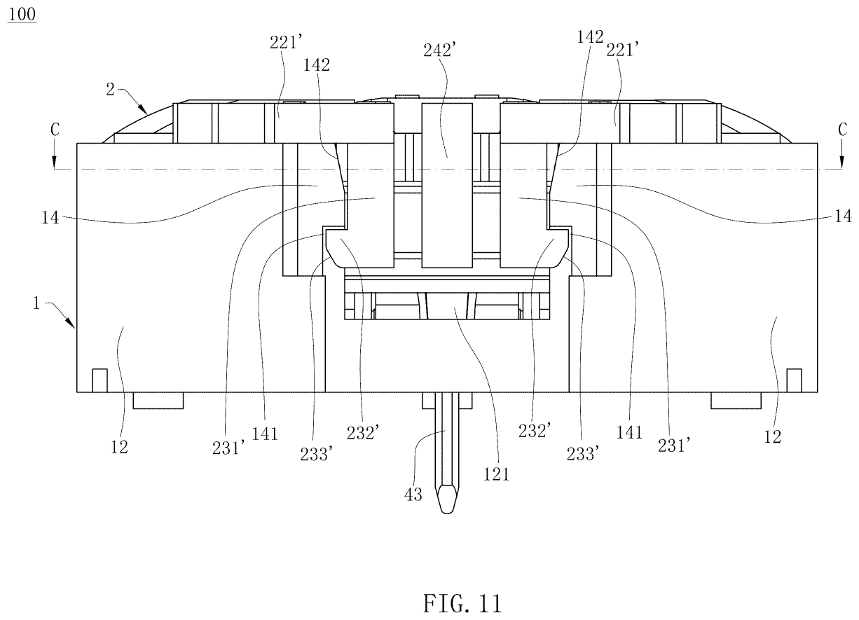

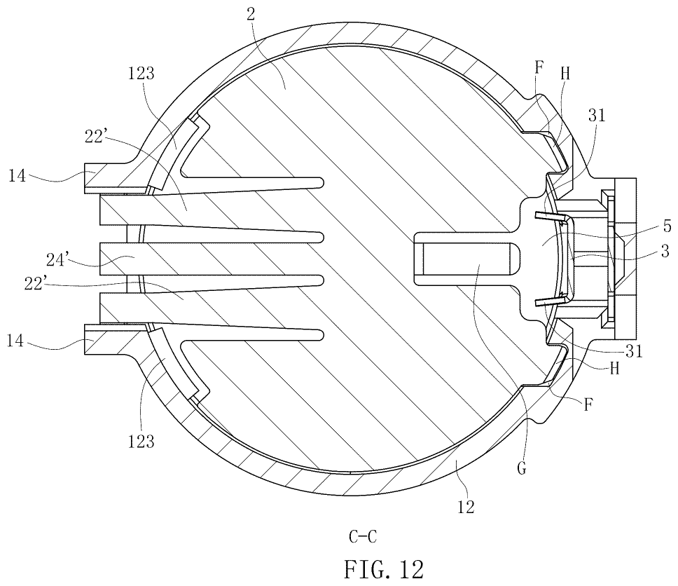

The description will be made as to the embodiments of the present invention in conjunction with the accompanying drawings in FIGS. 1-18. In accordance with the purposes of this invention, as embodied and broadly described herein, this invention, in one aspect, relates to a battery holder.

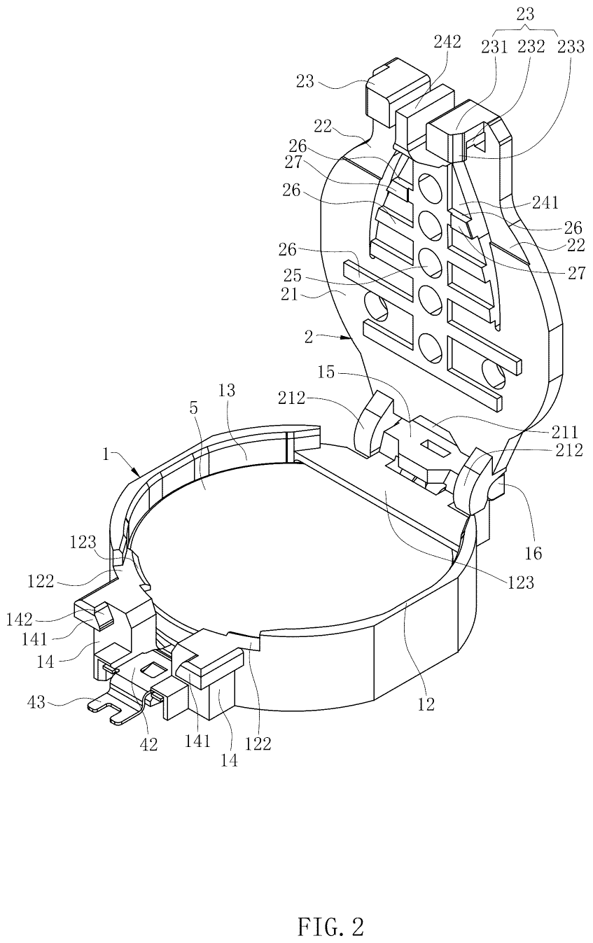

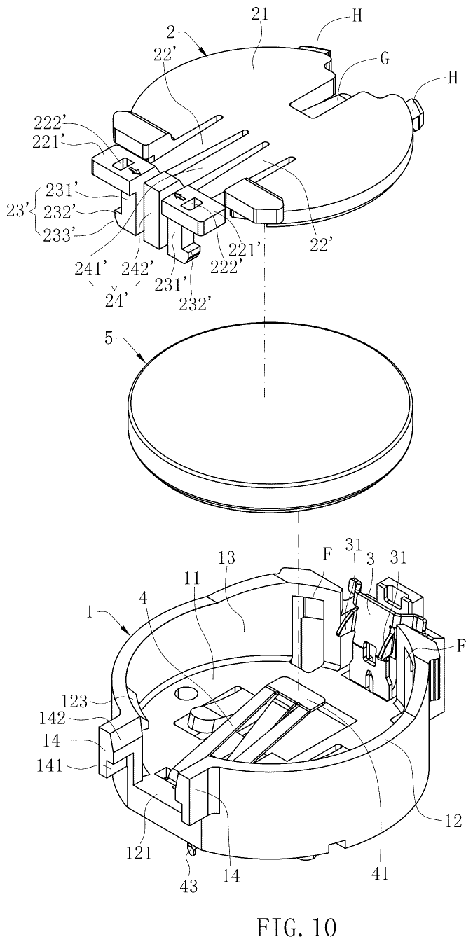

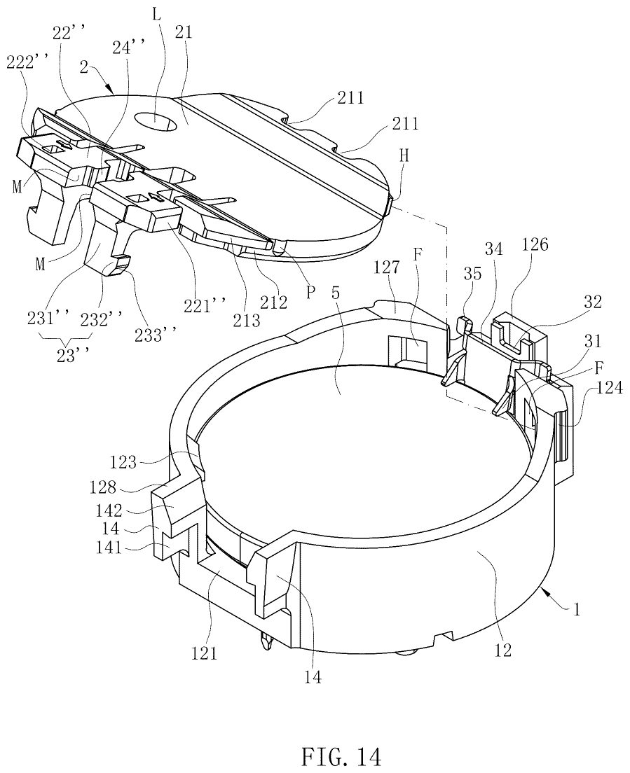

Referring to FIG. 1, FIG. 2, FIG. 10 and FIG. 14, the battery holder 100 according to certain embodiments of the present invention is used to accommodate a battery 5, and includes a base body 1, a positive elastic sheet 3 and a negative clastic sheet 4 respectively accommodated in the base body 1 and electrically connected to the battery 5, and a cover 2 covering the base body 1 to shield the battery 5.

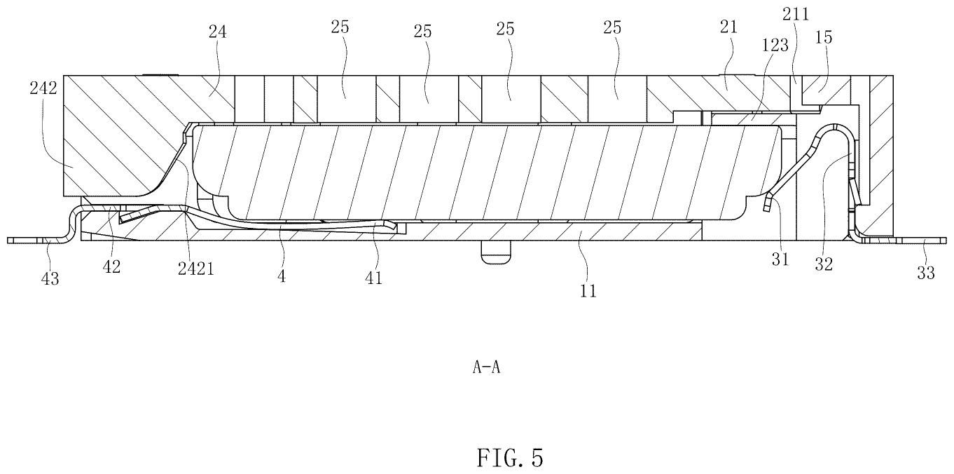

FIG. 1 to FIG. 8 show a first embodiment of the present invention. The base body 1 is formed by an insulating material. The base body 1 has a bottom wall 11 and a surrounding wall 12 extending upward from an edge of the bottom wall 11, and the bottom wall 11 and the surrounding wall 12 collectively form an accommodating cavity 13 to accommodate the battery 5. The surrounding wall 12 shields most of a side surface of the battery 5. A side of the surrounding wall 12 is provided with a groove 121 running therethrough, which allows the battery 5 to be detached by fingers entering the groove 121 after the cover 2 and the base body 1 are separated, without the need of specialized tools, thus facilitating the convenience of detaching the battery 5. The base body 1 is provided with a locking portion 141 at each of two opposite sides of the groove 121. Specifically, the base body 1 is provided with a mounting portion 14 protruding outward at each of the two sides of the groove 121, and a side edge of each of the two mounting portions 14 away from the groove 121 is provided with a locking portion 141 to lock and match with the cover 2, in order to fix the cover 2 to the base body 1 along an up-down direction. An upper surface of each locking portion 141 is flush with an upper surface of a corresponding mounting portion 14. Two reserved notches 122 are concavely formed downward at locations adjacent to the groove 121 from an upper surface of the surrounding wall 12, and in a left-right direction, the two reserved notches 122 are respectively located at the two sides of the groove 121 and in communication with the groove 121. Another side of the base body 1 opposite to the groove 121 is provided with a positioning block 15, and a pivot 16 is provided to protrude from each of two sides of the positioning block 15 along the left-right direction. In the left-right direction, the two pivots 16 are respectively located at two sides of the positive elastic sheet 3. An inner surface of the surrounding wall 12 is protrudingly provided with a plurality of stopping portions 123 to stop the upper surface of the battery 5, in which a stopping area of the stopping portion 123 closer to the positive elastic sheet 3 is greater than a stopping area of the stopping portion 123 closer to the negative elastic sheet 4. As shown in FIG. 1, FIG. 2 and FIG. 5, each of the positive elastic sheet 3 and the negative elastic sheet 4 has a fixing portion 32, 42 fixedly mounted on the base body 1, a contact portion 31, 41 extending from one side of the fixing portion 32, 42 to the accommodating cavity 13 to be electrically connected to the battery 5 and a soldering portion 33, 43 extending from another side of the fixing portion 32, 42 out of the accommodating cavity 13 to be electrically connected to a circuit board (not shown). One side of each of the two mounting portions 14 closer to the groove 121 is concavely provided with a retaining slot 143. Two sides of the fixing portion 42 of the negative elastic sheet 4 are respectively retained and mounted in the two retaining slots 143, and a middle portion of the fixing portion 42 of the negative elastic sheet 4 is located in the groove 121. The positive elastic sheet 3 is mounted at a side of the base body 1 away from the groove 121, and the positive elastic sheet 3 is located below the positioning block 15. The contact portion 31 of the positive elastic sheet 3 and the contact portion 41 of the negative elastic sheet 4 both elastically abut upward against the battery 5. The contact portion 31 of the positive elastic sheet 3 is higher than the contact portion 41 of the negative elastic sheet 4. The contact portion 31 of the positive elastic sheet 3 abuts against the side surface of the battery 5, and the contact portion 41 of the negative elastic sheet 4 abuts against the lower surface of the battery 5.

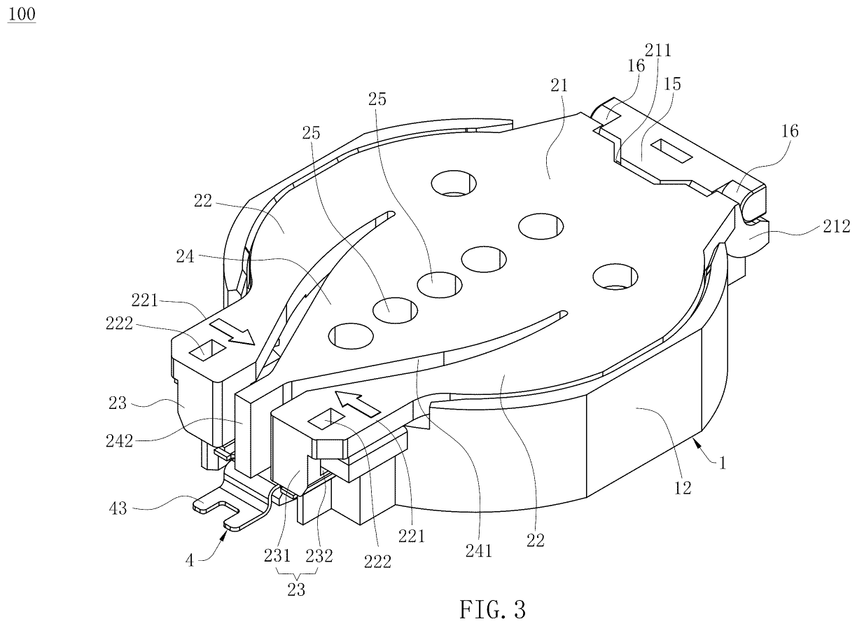

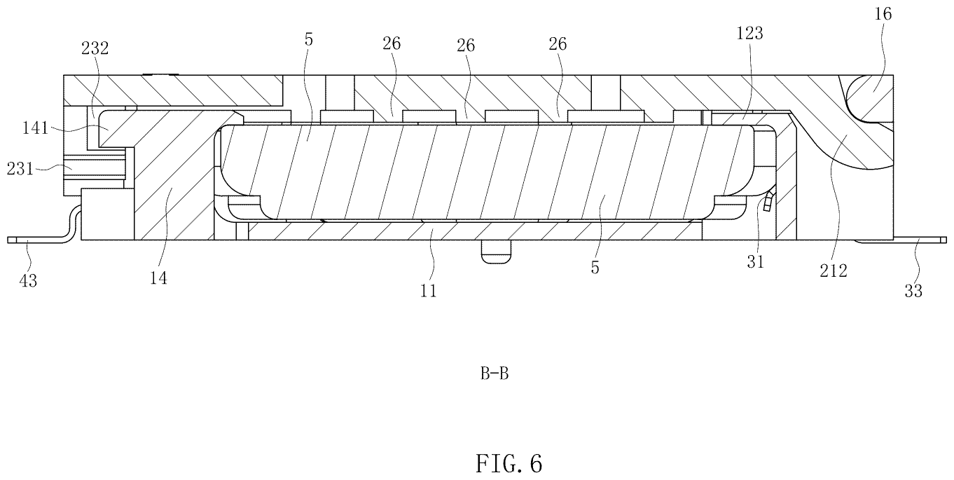

As shown in FIG. 1 to FIG. 3, the cover 2 is formed by an insulating material. In other embodiments, the cover 2 may be formed by a metal material. The cover 2 has a base portion 21, and a limiting structure extends from one side of the base portion 21 to be detachably assembled to the base body 1. Specifically, in the present embodiment, one side of the base portion 21 is concavely provided with a limiting slot 211, and a rotating portion 212 is protrudingly provided at each of two sides of the limiting slot 211. In the present embodiment, the two rotating portions 212 are in semi-curved shapes to allow easy detachment of the cover 2. As shown in FIG. 3 and FIG. 6, when the cover 2 is operated to rotate downward around the pivots 16 of the base body 1 and covers a top portion of the base body 1, the rotating portions 212 rotate to be below the pivots 16, the pivots 16 stop the rotating portions 212 of the cover 2 from moving upward, and the limiting slot 211 of the cover 2 and the positioning block 15 of the base body 1 match together to limit the position of the cover 2 in the left-right direction. That is, the limiting structure exerts the limiting function to limit the one side of the cover 2 to one side of the base body 1. The stopping portion 123 closest to the pivots 16 is close to the positive elastic sheet 3 and located above the contact portion 31 of the positive elastic sheet 3, and the stopping portion 123 closest to the pivots 16 abuts downward against the battery 5, thus ensuring the battery 5 and the contact portion 31 of the positive elastic sheet 3 are in full elastic contact. When there is a need to detach the cover 2, the cover 2 is flipped upward to be in an opening state, the rotating portions 212 rotate to be above the pivots 16, and the positioning block 15 is released from the limiting slot 211. In this case, the rotating portions 212 are not limited, and the cover 2 and the base body 1 may be capable of being detached and separated.

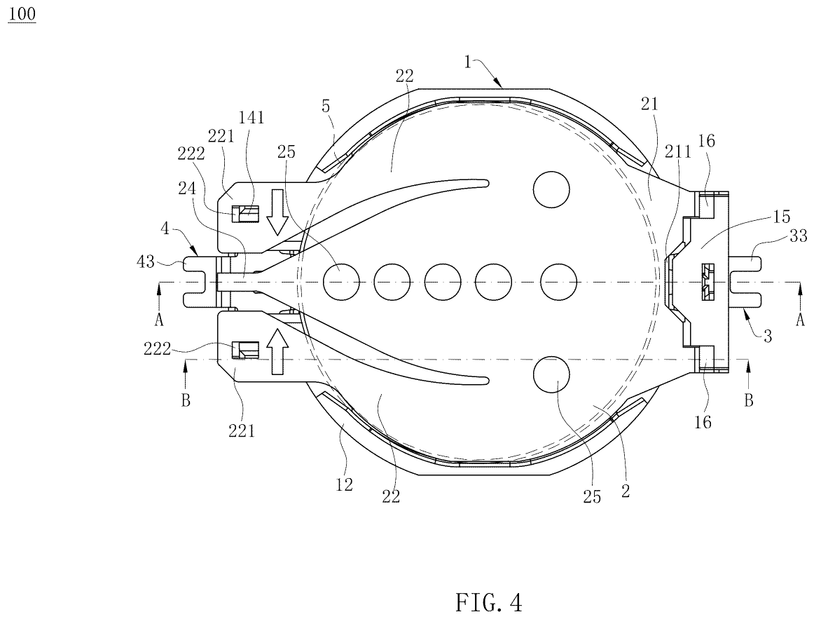

As shown in FIG. 4 to FIG. 8, another side of the base portion 21 opposite to the limiting structure is provided with two elastic arms 22 extending along a front-rear direction and an auxiliary portion 24 located between the two elastic arms 22. One side of each elastic arm 22 away from the base portion 21 is provided with a latching section 23 extending downward. The base portion 21 and the auxiliary portion 24 are both provided with a plurality of heat dissipation holes 25 running downward therethrough for heat dissipation, the battery 5 is exposed in the heat dissipation holes 25. A diameter of each heat dissipation hole 25 is less than a minimum distance between two elastic arms 22. Thus, the heat dissipation holes 25 have a relatively small size, preventing the children from inserting their fingers into the heat dissipation holes 25. Lower surfaces of the base portion 21 and the auxiliary portion 24 are both protrudingly provided with a plurality of reinforcing ribs 26 to reinforce the strength of the base portion 21 and the auxiliary portion 24. A gap exists between a lower surface of each reinforcing rib 26 and the upper surface of the battery 5, thus preventing other reinforcing ribs 26 from interfering with the battery 5 when the cover 2 covers the base body 1, which results in the latching sections 23 of the cover 2 not being able to lock and fix with the base body 1. Each of the two reinforcing ribs 26 closest to the latching sections 23 is further protrudingly provided with a protruding block 27 along the up-down direction. The two protruding blocks 27 are both in contact with the upper surface of the battery 5, thus preventing the battery holder 100 from causing the battery 5 to shake in the accommodating cavity 13 in a vibrating environment. In addition, when the upper surface of the cover 2 is subjected to the collision of an external force, the collision force may be released to the battery 5 through the two protruding blocks 27, and the collision force is further released to the bottom wall 11 of the base body 1 through the battery 5, which finally transfers the collision force to the circuit board, thus preventing the cover 2 from being damaged. One side of each elastic arm 22 away from the base portion 21 is provided with an operational portion 221 and a through hole 222 running through the operational portion 221 along the up-down direction, allowing exerting the external force on the two operational portions 221 such that the two elastic arms 22 deflect toward each other. The two elastic arms 22 respectively pass through the corresponding reserved notches 122 and are partially located above the mounting portions 14. The two reserved notches 122 make space for the two elastic arms 22, thereby reducing the height of the battery holder 100. In addition, after the cover 2 is installed in place, the upper surface of the cover 2 is not higher than the top surface of the base body 1. Thus, the cover 2 does not add any extra height to the battery holder 100, thus facilitating the miniaturization of the battery holder 100. The upper surfaces of the two mounting portions 14 support the lower surfaces of the two elastic arms 22, allowing the two latching sections 23 to correspondingly lock the two locking portions 141. Each latching section 23 includes an extending portion 231 extending downward from a corresponding one of the elastic arms 22 and a buckling portion 232 provided on the extending portion 231 to lock and fix to a corresponding locking portion 141. In the present embodiment, the two buckling portions 232 are provided as engaging slots concavely formed on the inner side surfaces of the two extending portions 231, and the two locking portions 141 are provided as engaging blocks formed by protruding from side edges of the two mounting portions 14 away from the groove 121. In other embodiments, the two buckling portions 232 may be provided as engaging blocks, and the two locking portions 141 may be provided as engaging slots, as long as the two locking portions 141 and the two buckling portions 232 may lock and fix together along the up-down direction.

As shown in FIG. 3 and FIG. 5 to FIG. 7, in the present embodiment, since the locking portions 141 are engaging block structures, after the cover 2 is assembled to be in place, each engaging block is aligned to each through hole 222 in the up-down direction, such that each engaging block is exposed to the corresponding through hole 222 in the up-down direction, allowing observation of the locking condition of the engaging block and the engaging slot through the corresponding through hole 222. An upper end of one side of each of the two locking portions 141 facing each other is provided with a first oblique surface 142 being obliquely downward, and each buckling portion 232 is concavely formed downward from an upper end of an inner side surface of each extending portion 231. A lower end of one side of each of the two latching sections 23 away from each other is provided with a second oblique surface 233 being obliquely upward. In the present embodiment, the second oblique surface 233 is provided at a lower end of a corresponding extending portion 231, the second oblique surface 233 is located below a corresponding buckling portion 232, and the first oblique surface 142 and the second oblique surface 233 match together to collectively guide the two extending portions 231 to move downward, such that the two buckling portions 232 deflect to be close to each other and simultaneously lock downward to the two locking portions 141 to fix the cover 2 to the base body 1 along the up-down direction.

As shown in FIG. 5 to FIG. 8, the auxiliary portion 24 includes a first section 241 extending from the base portion 21 along the front-rear direction and provided at intervals with the two elastic arms 22, and a second section 242 extending downward from one side of the first section 241 away from the base portion 21. A width of the first section 241 of the auxiliary portion 24 is greater than a width of each of the two elastic arms 22. The first section 241, the base portion 21 and the two elastic arms 22 collectively shield the upper surface of the battery 5, and the second section 242 enters the groove 121 and shields a portion of the side surface of the battery 5 exposed in the groove 121. In the present embodiment, the two elastic arms 22 are respectively located at two side edges of the cover 2, and the outer side edges of the two elastic arms 22 are in curved shapes to be close to the inner surface of the surrounding wall 12, thus preventing gaps between the two elastic arms 22 and the surrounding wall 12 from being excessively large to cause the children to insert their fingers therein. In addition, the outer side edges of the two elastic arms 22 do not pass the outer side surface of the surrounding wall 12, thereby ensuring the miniaturization of the volume of the battery holder 100. A width of the first section 241 of the auxiliary portion 24 in an extending direction of the elastic arms 22 gradually decreases, such that a distance between the first section 241 and each clastic arm 22 is always less than a width of the finger of a child. A distance between the second section 242 and each of the two latching sections 23 is less than a width of each latching section 23. That is, the distance between the second section 242 and each of the two latching sections 23 is less than the width of the finger of a child, and the distance between the first section 241 and each of the two elastic arms 22 is also less than the width of the finger of a child, such that the children do not easily notice the battery 5, and the children cannot insert their fingers into the accommodating cavity 13, thus preventing the children from reaching into the accommodating cavity 13 from the top of the accommodating cavity 13 or from the groove 121 and easily taking out the battery 5, and preventing the children from accidentally ingesting the battery 5. A portion of the second section 242 close to the battery 5 is used to shield the side surface of the battery 5, and another portion of the second section 242 is located between the two latching sections 23 to stop the two latching sections 23 from excessively deflecting toward each other. A minimum lateral width of the portion of the second section 242 close to the battery 5 is greater than or equal to a lateral width of the other portion of the second section 242, such that the portion of the second section 242 close to the battery 5 may fully shield the side surface of the battery 5, and the other portion of the second section 242 makes space for the two latching sections 23 to deflect toward each other, thus providing a reserved space. One side of the second section 242 facing the battery 5 forms a guiding curved surface 2421, and the guiding curved surface 2421 guides the second section 242 to cross over the battery 5 above the battery 5 and enters the groove 121, thus preventing the second section 242 from colliding with the battery 5. An upper surface of the first section 241 is flush with the upper surface of each elastic arm 22, and a lower surface of the second section 242 is flush with the lower surface of each latching section 23 or passes downward beyond the lower surface of each latching section 23, thus ensuring the second section 242 to fully block the two latching sections 23 from excessively deflecting toward each other. The negative elastic sheet 4 is located below the second section 242, and in the up-down direction, a gap exists between the lower surface of the second section 242 and the negative elastic sheet 4, thus preventing the second section 242 and the negative elastic sheet 4 from contacting and colliding. In the present embodiment, the auxiliary portion 24 shields the side surface of the battery 5 exposed in the groove 121, and the mounting portions 14 and the surrounding wall 12 shield the remaining portion of the side surface of the battery 5. In other embodiments, the auxiliary portion 24 and the latching sections 23 may simultaneously shield the side surface of the battery 5 exposed in the groove 121, as long as it is ensured to have better shielding effect.

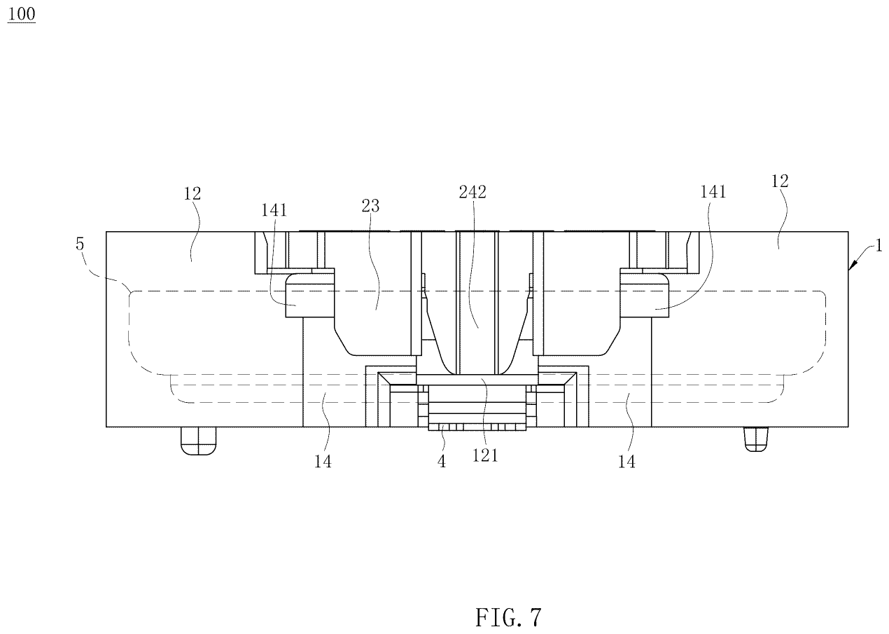

As shown in FIG. 3, FIG. 4 and FIG. 7, the first section 241 extends along the front-rear direction, and the second section 242 extends along the up-down direction, such that the auxiliary portion 24 is in an overall cantilever shape and has elasticity. The section 242 is located between the two latching sections 23 outside the surrounding wall 12, and gaps exist between a left side and a right side of the second section 242 and the two latching sections 23, thus allowing the auxiliary portion 24 to follow the two latching sections 23 to elastically deflect altogether to provide a soft cushioning effect when the two latching sections 23 excessively deflect and abut against the second section 242, preventing an excessive interference force between the latching sections 23 and the auxiliary portion 24 that damages the latching sections 23. An extending length of the first section 241 of the auxiliary portion 24 along the front-rear direction is equal to a length of each elastic arm 22, a width of the second section 242 is less than or equal to a width of the first section 241, and the width of the second section 242 is less than or equal to a width of each latching section 23. In the present embodiment, the width of the second section 242 is less than the width of the first section 241 and is also less than the width of each latching section 23, such that the second section 242 has a thin lengthy structure with better elasticity. In other embodiments, the width of the second section 242 may be equal to the width of the first section 241 and equal to the width of each latching section 23. In the mounting process of the cover 2, when mounting tolerances exist to cause the two latching sections 23 to excessively deflect toward each other and be in contact with the second section 242, the second section 242 in turn provides a sufficient force to correct the positions of the two latching sections 23, thus ensuring the two latching sections 23 to be normally locked to the two locking portions 141, preventing excessive deformation and damage to the two latching sections 23, ensuring the structural strength of the two latching sections 23, increasing the usage life of the battery holder 100, and reducing the tolerance and dimension requirements, which is conducive to reducing the manufacturing cost of the battery holder 100. In the present embodiment, the auxiliary portion 24 is formed by integrally extending from the cover 2, which is conducive to reducing the matching and assembling tolerances between the latching sections 23 and other structures (except the locking portions 141) of the base body 1 in the mounting process of the cover 2, and further reducing the manufacturing cost. In other embodiments, the elastic auxiliary portion 24 may extend from the base body 1, and the cushioning effect is obtained as long as the elastic auxiliary portion 24 is located between the two latching sections 23, thus preventing the two latching sections 23 from excessively deflecting and damaging, and reducing the manufacturing tolerance and saving the cost.

As shown in FIG. 1, FIG. 2 and FIG. 7, when there is a need to take out the battery 5, it is required to press on the two operational portions 221 of the cover 2 along the left-right direction, such that the two elastic arms 22 of the cover 2 deflect to be close to each other, and the two buckling portions 232 are close to each other to be correspondingly released from the two locking portions 141 of the base body 1. Then, the cover 2 is operated such that the two rotating portions 212 rotate around the two pivots 16 of the base body 1, such that the one side of the cover 2 provided with the two elastic arms 22 is flipped upward. Then, the cover 2 is taken out upward such that the two rotating portions 212 of the cover 2 are separated from the two pivots 16 of the base body 1, thus separating the cover 2 and the base body 1. By firstly pressing on the two operational portions 221 such that the two buckling portions 232 are released from the two locking portions 141 of the base body 1, and then flipping the cover 2 such that the two rotating portions 212 of the cover 2 are separated from the two pivots 16 of the base body 1, the two-step operation allows the children not to easily take out the battery 5, thus preventing the children from accidentally ingesting the battery 5.

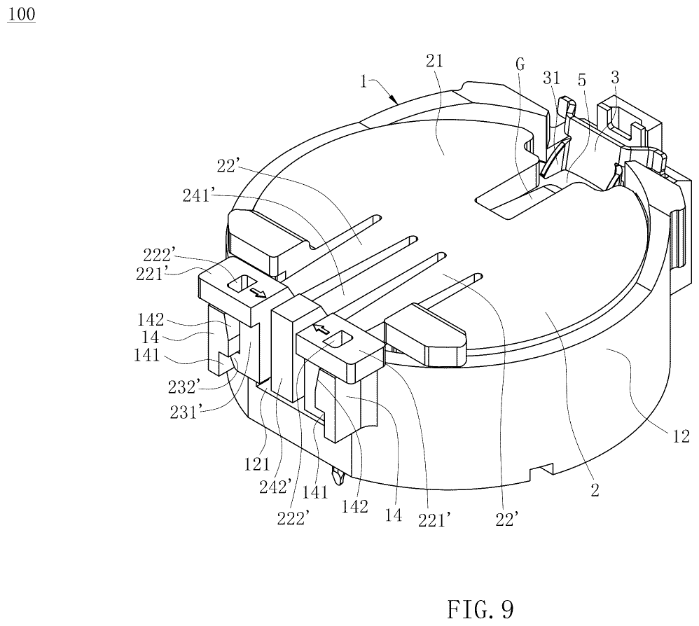

FIG. 9 to FIG. 12 show a battery holder 100 according to a second embodiment of the present invention. In the second embodiment, the cover 2 is not pivoted to the base body 1, and is instead mounted to the base body 1 by oblique insertion, and the appearances of the two elastic arms 22′ of the cover 2 are different from the appearances of the two clastic arms 22 in the first embodiment. Specifically, the two elastic arms 22′ extend from the middle of the base portion 21 along a front-rear direction. Along the up-down direction, a thickness of the operational portion 221′ of each elastic arm 22′ is greater than a thickness of other portions of the elastic arm 22′, and the operational portion 221′ is provided with a through hole 222′ running therethrough along the up-down direction. The two elastic arms 22′ are provided side-by-side, and the auxiliary portion 24′ is located between the two elastic arms 22′. The inner surface of the side of the surrounding wall 12 provided with the groove 121 is protrudingly provided with a plurality of stopping portions 123. The negative elastic sheet 4 is mounted on the bottom wall 11 of the base body 1. The positive elastic sheet 3 is mounted on the side of the surrounding wall 12 away from the groove 121. The contact portions 31 of the positive elastic sheet 3 are located at an upper side of the battery 5 to be in electrical contact with the upper surface of the battery 5. The contact portions 31 of the positive elastic sheet 3 and the stopping portions 123 are respectively located at two opposite sides above the battery 5 to collectively stop the battery 5. The other side of the surrounding wall 12 opposite to the groove 121 is provided with two clamping slots F running therethrough, and in the left-right direction, the two clamping slots F are respectively located at two sides of the positive elastic sheet 3. The base portion 21 is provided with an abutting portion G in an elastic sheet shape and protruding downward. The two contact portions 31 of the positive elastic sheet 3 are respectively located at two outer sides of the extending lines of the two side edges of the abutting portion G, and the abutting portion G extends downward to abut against the battery 5, thus preventing the battery 5 from shaking in the accommodating cavity 13. The limiting structure includes two limiting blocks H protrudingly provided from one side of the base portion 21 of the cover 2 at an interval. One side of the cover 2 provided with the limiting blocks H is obliquely inserted toward one side of the base body 1 provided with the positive elastic sheet 3, such that the two limiting blocks H of the cover 2 are inserted into the two clamping slots F of the base body 1, thus limiting the side of the cover 2 provided with the limiting blocks H from moving upward. Each of the two locking portions 141 is an engaging slot concavely formed from one side of each of the two mounting portions 14 facing each other. The sides of the two mounting portions 14 facing each other are provided with first oblique surfaces 142 being obliquely downward from an upper end thereof, and the two first oblique surfaces 142 are located above the engaging slots. Each of the two buckling portions 232′ is an engaging block formed by protruding from one side of each of the two extending portions 231′ away from each other. The sides of the two latching sections 23′ away from each other are provided with second oblique surfaces 233′ being obliquely upward from a lower end thereof. In the present embodiment, the second oblique surfaces 233′ are located at the lower ends of the buckling portions 232′, and the first oblique surfaces 142 and the second oblique surfaces 233′ match with each other to collectively guide the two latching sections 23′ to move downward, such that the two latching sections 23′ respectively lock and fix with the two locking portions 141. A portion of the first section 241′ located between the two operational portions 221′ stops the two elastic arms 22′ from excessively deflecting toward each other, and the second section 242′ and the two latching sections 23′ are located in the groove 121. A distance between the first section 241′ and each of the two elastic arms 22′ is less than or equal to a distance between the second section 242′ and each of the two latching sections 23′, and the distance between the second section 242′ and each of the two latching sections 23′ is less than a width of a finger of a child, such that the upper surface of the battery 5 and the portion of the side surface of the battery 5 exposed in the groove 121 are shielded, such that the children do not easily notice the battery 5, and the children cannot insert their fingers into the accommodating cavity 13, thus preventing the children from reaching into the accommodating cavity 13 from the top of the accommodating cavity 13 or from the groove 121 and easily taking out the battery 5.

When there is a need to take out the battery 5, the two buckling portions 232′ are firstly released correspondingly from the two locking portions 141. Then, the one side of the cover 2 provided with the two elastic arms 22′ is raised upward, such that the two elastic arms 22′ of the cover 2 get out of the groove 121 of the base body 1. Then, the cover 2 is obliquely pulled out, such that the two limiting blocks H of the cover 2 get out of the two clamping slots F of the base body 1, thereby separating the cover 2 and the base body 1.

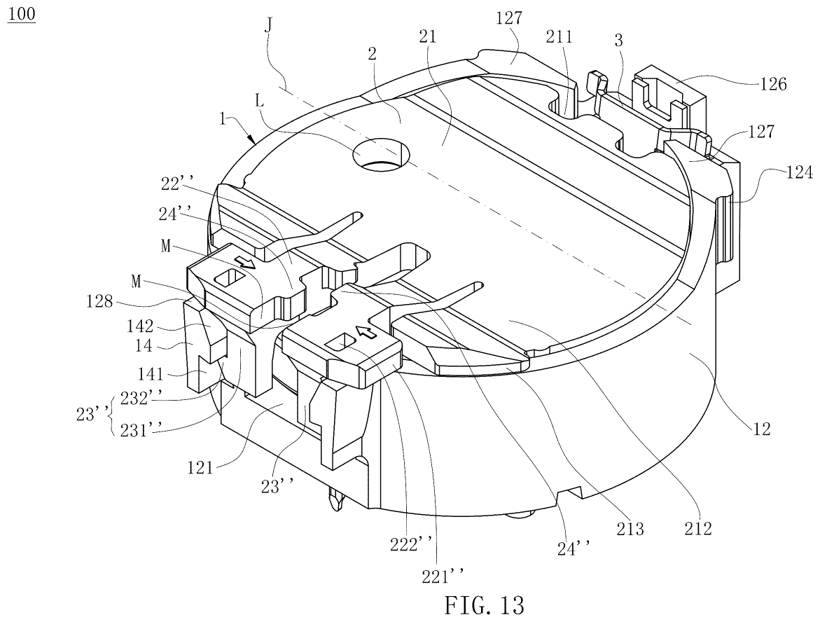

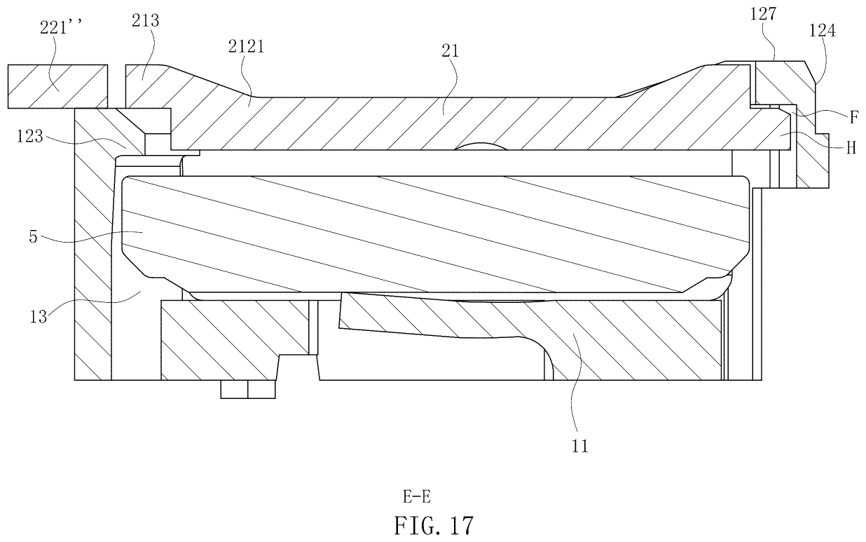

FIG. 13 to FIG. 18 show a battery holder 100 according to a third embodiment of the present invention. The cover 2 is also mounted to the base body 1 by being inserted obliquely, and the surrounding wall 12 is concavely provided with two clamping slots F at an interval. Two limiting blocks H extend from one side of the base portion 21 of the cover 2. In assembling the cover 2, the two limiting blocks H may be firstly inserted obliquely into the two clamping slots F correspondingly, and then be placed in the two clamping slots F horizontally. As shown in FIG. 17, the top surfaces of the limiting blocks H are stopped by the upper surfaces of the clamping slots F, such that the side of the cover 2 provided with the limiting blocks H cannot be released upward from the base body 1. That is, the upper surfaces of the clamping slots F stop the side of the cover 2 provided with the limiting blocks H from moving upward. In addition, two sides of each limiting block H are limited in the inner surfaces of the corresponding clamping slot F, thus limiting the cover 2 from moving along the left-right direction or rotating along the peripheral direction. In addition, a length of each clamping slot F along the up-down direction is greater than a thickness of each limiting block H along the up-down direction. When the cover 2 is collided by an external force, the clamping slots F allow the limiting blocks H to move downward, and the side of the cover 2 provided with the limiting blocks H may abut against the upper surface of the battery 5 to transfer the collision force to the battery 5, and the collision force is further transferred to the bottom wall 11 of the base body 1 through the battery 5, which finally transfers the collision force to the circuit board, thus preventing the cover 2 from being damaged, such that the cover 2 may sustain a greater collision force, preventing the cover from being broken and exposure of the battery 5.

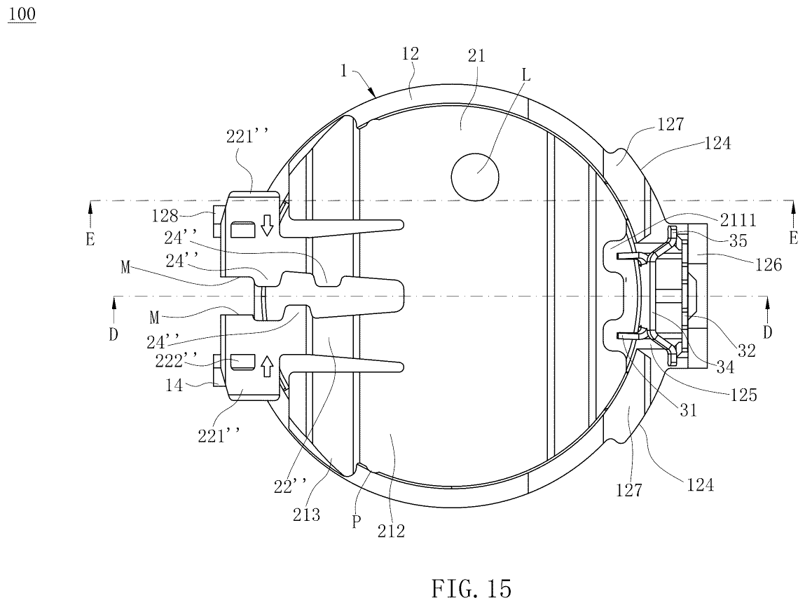

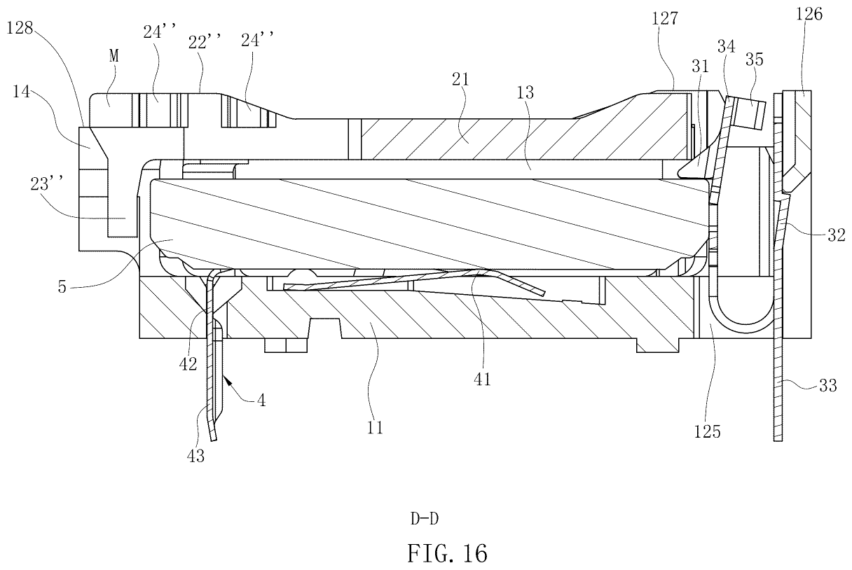

As shown in FIG. 14, the surrounding wall 12 has a first top surface 127 correspondingly located right above each clamping slot F. The upper surface of each mounting portion 14 is a second top surface 128, and the second top surface 128 is lower than the first top surface 127. The surrounding wall 12 is provided with two reinforcing portions 124 protruding outward above the two clamping slots F, and a thickness of the surrounding wall 12 at the locations provided with the reinforcing portions 124 along a wall thickness direction of the surrounding wall 12 is greater than a thickness of the other portions of the surrounding wall 12, thus reinforcing the strength of the base body 1. An upper surface of each reinforcing portion 124 is flush with the first top surface 127. The base body 1 is provided with a elastic sheet slot 125 between the two reinforcing portions 124 to accommodate the positive elastic sheet 3. The clastic sheet slot 125 and the accommodating cavity 13 are in communication with each other, one side of the elastic sheet slot 125 away from the accommodating cavity 13 is provided with a protruding wall 126. Referring to FIG. 10, in the present embodiment, the structures of the positive elastic sheet 3 and the negative elastic sheet 4 are identical to the structures of the positive elastic sheet 3 and the negative clastic sheet 4 in the second embodiment. As shown in FIG. 16, the fixing portion 32 of the positive elastic sheet 3 is fixed to the protruding wall 126. The positive elastic sheet 3 is provided with a moving portion 34 bending and extending from its fixing portion 32 toward the elastic sheet slot 125. The fixing portion 32 and the moving portion 34 are connected in a U-shape, and a space exists between the moving portion 34 and the fixing portion 32 to allow the moving portion 34 to deform toward one side close to the fixing portion 32. The moving portion 34 is provided with two contact portions 31 protruding toward the accommodating cavity 13 and two bending sheets 35 extending away from the accommodating cavity 13. The two bending sheets 35 are located outside the surrounding wall 12 and are higher than the two contact portions 31 of the positive elastic sheet 3, and the upper surfaces of the clamping slots F are also higher than the top ends of the contact portions 31 of the positive elastic sheet 3. Before the battery 5 is installed in the accommodating cavity 13, the two bending sheets 35 are stopped by the outer surface of the surrounding wall 12 (not shown in the figures) to limit the moving portion 34, and as shown in FIG. 14 and FIG. 16, when the battery 5 is installed in the accommodating cavity 13, the side surface of the battery 5 abuts against the moving portion 34, and the two contact portions 31 of the positive elastic sheet 3 are located at the upper side of the battery 5 to be in electrical contact with the upper surface of the battery 5. In addition, when there is a need to take out the battery 5, the moving portion 34 is further pushed toward a side close to the fixing portion 31, such that the two contact portions 31 of the positive elastic sheet 3 correspondingly move outward without stopping the upper side of the battery 5, and the battery 5 may be taken out. As shown in FIG. 15, one side of the base portion 21 close to the positive elastic sheet 3 is concavely provided with two reserved slots 211, and the two contact portions 31 of the positive elastic sheet 3 are respectively accommodated in the two reserved slots 211 correspondingly, thus preventing the cover 2 from colliding with the two contact portions 31 of the positive elastic sheet 3 when being inserted obliquely thereto, thus facilitating the contact portions 31 of the positive elastic sheet 3 to be in good contact with the battery 5, and stopping the battery 5 from moving upward. The base portion 21 is provided with an observation hole L running therethrough along the up-down direction, such that an external personnel or an external inspection equipment may inspect whether a battery 5 is installed in the base body 1 through the observation hole L. As shown in FIG. 15, a diameter of the observation hole L is less than a distance between the two contact portions 31 of the positive elastic sheet 3. Thus, the observation hole L has a relatively smaller size, preventing the children from inserting their fingers into the observation hole L to touch the battery 5.

As shown in FIG. 10 and FIG. 14, the positive elastic sheet 3 and the groove 121 are provided to be opposite to each other along the front-rear direction and are respectively located at two opposite sides of the battery 5, and the negative elastic sheet 4 is mounted on the bottom wall 11 of the base body 1. Viewing along the front-rear direction, the negative elastic sheet 4 may be exposed in the groove 121, and the negative elastic sheet 4 is provided to be closer to the locking portions 141 relative to the positive elastic sheet 3. As shown in FIG. 16, the fixing portion 42 of the negative elastic sheet 4 is inserted and fixed to the bottom wall 11, and a contact portion 41 extends obliquely from the fixing portion 42 toward the accommodating cavity 13. A height of the contact portion 41 of the negative elastic sheet 4 is lower than a height of the contact portion 31 of the positive elastic sheet 3, and the contact portion 41 of the negative elastic sheet 4 is in electrical contact with the lower surface of the battery 5.

As shown in FIG. 14, another side of the base portion 21 opposite to the limiting blocks H is provided with two elastic arms 22″ extending along the front-rear direction. One side of each elastic arm 22″ away from the base portion 21 is provided with an operational portion 221″. A latching section 23″ extends downward from the operational portion 221″ of each elastic arm 22″, and each latching section 23″ includes an extending portion 231″ extending downward from the corresponding elastic arm 22″ and a buckling portion 232″ provided on the extending portion 231″ to lock and fix with the corresponding locking portion 141. As shown in FIG. 19, the two locking portions 141 are concavely formed from the sides of the two mounting portions 14 facing each other, and the two buckling portions 232″ are protrudingly formed from the sides of the two extending portions 231″ away from each other.

In the process of the cover 2 being mounted to the base body 1, the side of the cover 2 provided with the latching sections 23″ is pressed downward, and the two buckling portions 232″ are abutted by the first oblique surfaces 142 of the two mounting portions 14, such that the two elastic arms 22″ deflect to be close to each other, and the first oblique surfaces 142 and the second oblique surfaces 233″' match each other to guide the two latching sections 23″' to move downward to enter the groove 121. The two side surfaces of the two elastic arms 22″ facing each other are provided with two anti-excessive deflection surfaces M, and the two anti-excessive deflection surfaces M may abut against each other to prevent the two elastic arms 22″ from excessively deflect toward each other. Specifically, the anti-excessive deflection surfaces M are the two side surfaces of the two operational portions 221″ facing each other, and when the two operational portions 221″ do not deflect toward each other, a gap between the two anti-excessive deflection surfaces M is greater than a protruding size of each buckling portion 232″ to allow the extending portions 231″ and the operational portions 221″ to simultaneously deflect and deform inward, thus preventing from the case where the extending portions 231″ and the operational portions 221″ cannot simultaneously deflect and deform inward in the process of mounting the cover 2, which causes the connecting location between the two is subjected to an excessive force and breaks. After the pressing is stopped, the two elastic arms 22″ return to the status without deflecting toward each other by their own elasticity, and in this case, the buckling portions 232″ lock to the locking portions 141. The two anti-excessive deflection surfaces M are provided to be closer relative to the two extending portions 231″, that is, the gap between the two anti-excessive deflection surfaces M is less than a distance between the two extending portions 231″, thus preventing the gap between the two anti-excessive deflection surfaces M from being excessively large to cause the children to easily insert their fingers into the groove 121 to touch the battery 5.

When there is a need to take out the battery 5, the two operational portions 221″ are pressed along the left-right direction, such that the two elastic arms 22″ move toward each other, and the extending portions 231″ and the operational portions 221″ may simultaneously deflect and deform inward until the two buckling portions 232″ are correspondingly released from the two locking portions 141. Then, one side of the cover 2 provided with the two elastic arms 22″ is taken out upward such that the latching sections 23″ of the cover 2 are released upward from the groove 121 of the base body 1, and the cover 2 is obliquely pulled out, such that the two limiting blocks H of the cover 2 are released from the two clamping slots F, thereby taking out the cover 2. Then, the positive clastic sheet 3 is pulled toward a direction away from the accommodating cavity 11. Finally, the battery 5 may be capable of being detached from one side of the groove 121.

When the force pressed and exerted onto the two operational portions 221″ is excessively large, the two anti-excessive deflection surfaces M may abut against each other to prevent the two elastic arms 22″ from excessively deflecting, deforming or breaking, thus reinforcing the structural strength of the elastic arms 22″ and increasing the usage life of the cover 2, and ensuring that the latching sections 23″ may lock to the locking portions 141 normally in the subsequent mounting and usage process of the cover 2, thereby allow the cover 2 to shield and protect the battery 5. In other embodiments, a side surface of at least one auxiliary portion 24″ located on each elastic arm 22″ and the side surface of the elastic arm 22″ opposite thereto form the two anti-excessive deflection surfaces M, and the side surface of the auxiliary portion 24″ and the side surface of the elastic arm 22″ opposite thereto abut against each other to prevent the two elastic arms 22″ from excessively deflecting. In addition, in other embodiments, it is possible that the base body 1 is provided with other protruding structures, and the two anti-excessive deflection surfaces M of the two elastic arms 22″ respectively abut against the protruding structures to stop the two elastic arms 22″ from excessively deflecting.

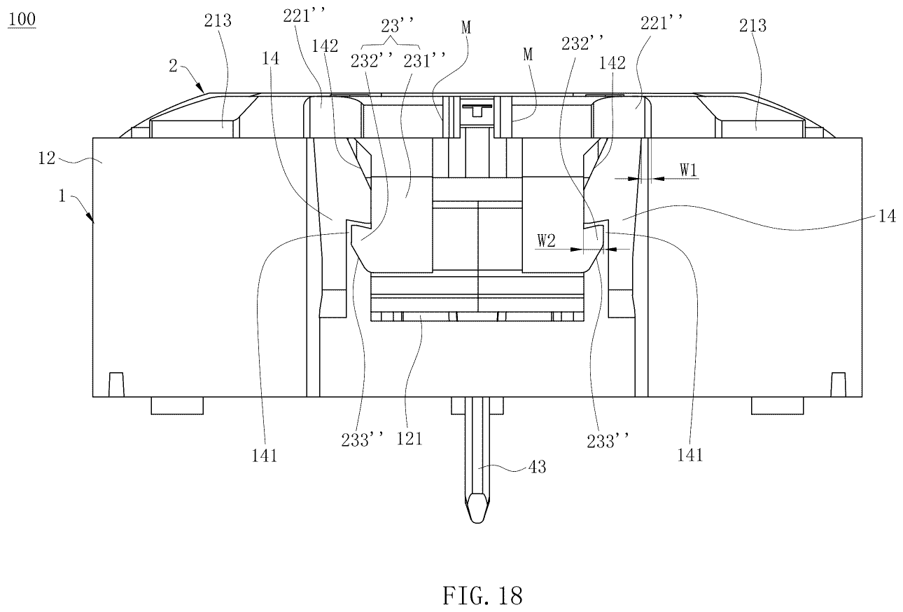

As shown in FIG. 13, FIG. 15 and FIG. 18, when the cover 2 has been mounted to the base body 1, the surrounding wall 12 shields most of the side surface of the battery 5, and the two latching sections 23″ are located in the groove 121 to shield the side surface of the battery 5 exposed in the groove 121. In addition, a distance between the two latching sections 23″ is less than a width of a finger of a child, such that the children do not easily touch the battery 5. The base portion 21 and the two elastic arms 22″ shield the upper surface of the battery 5, and at least one auxiliary portion 24″ is formed by protruding from one side of each of the two elastic arms 22″ close to each other along the left-right direction. A projection of one of the auxiliary portions 24″ along the left-right direction overlaps with a projection of the operational portion 221″. The auxiliary portions 24″ may reinforce the strength of the two elastic arms 22″, such that the two elastic arms 22″ do not easily break. The auxiliary portions 24″ of the two elastic arms 22″ are provided to be staggered along the left-right direction. The auxiliary portions 24″ fill the gap between the two elastic arms 22″, thus preventing the children from inserting their fingers into the accommodating cavity 13, and the auxiliary portions 24″ shield the portion of the upper surface of the battery 5 exposed between the two elastic arms 22″. Thus, the battery holder assembled by the cover 2 and the base 1 shield and protect the battery 5. In addition, the auxiliary portions 24″ may be used to block the side edges of the adjacent elastic arm 22″, thereby preventing the two elastic arms 22″ from excessively deflecting toward each other. After the completion of the mounting of the cover 2, the top surfaces of two elastic arms 22″ are lower than the first top surfaces 127 of the surrounding wall 12, that is, the provision of the elastic arms 22″ do not increase any extra height to the battery holder 100, such that the battery holder 100 may maintain the original height, thus facilitating the miniaturization of the battery holder 100.

Referring to FIG. 13, FIG. 14 and FIG. 15, two shielding portions 212 extend from the base portion 21 along the front-rear direction and are respectively located at two outer sides of the two elastic arms 22″. The two shielding portions 212 are used to shield a portion of the upper surface of the battery 5. A slit exists between each shielding portion 212 and each elastic arm 22″, such that the elastic arms 22″ may deform by being independent from the shielding portions 212 to have better elasticity. The shielding portions 212 are located inside the surrounding wall 12, and each shielding portion 212 is provided with a projection point P abutting against the surrounding wall 12. Even though the elastic arms 22″ deform due to improper operation of the children, the projection point P of each shielding portion 212 may maintain a tight interference fit with the surrounding wall 12, such that the overall upward pulling force of the cover 2 increases, and the children cannot easily take out the cover 2. A supporting portion 213 is formed by protruding outward from one side of each shielding portion 212. A top surface of the supporting portion 213 is higher than a top surface of the base portion 21, bottom surfaces of the two supporting portions 213 are supported by the upper surface of the surrounding wall 12, and the two supporting portions 213 and the two elastic arms 22″ are located at the same side of a central line J of the cover 2 extending along the left-right direction. As shown in FIG. 13 and FIG. 14, the two supporting portions 213 and the two elastic arms 22″ are located at a front side of the base portion 21, and the limiting blocks F are located at a rear side of the base portion 21. The upper surface of the surrounding wall 12 stops the two supporting portions 213 from moving downward, thus preventing the two elastic arms 22″ and the two latching sections 23″ from moving downward due to the gravity to cause the two buckling portions 232″ and the two locking portions 141 loosen from each other. Each operational portion 221″ is correspondingly located above the second top surface 128 of each mounting portion 141, and the second top surface 128 stops the operational portion 221″ from moving downward, thus further preventing the buckling portions 232″ and the locking portions 141 from loosening, such that the cover 2 may be more stably mounted to the base body 1 in the up-down direction. In the present embodiment, the two operational portions 221″ are respectively located above the two mounting portions 14, and a distance W1 of an outer side edge of each of the two operational portions 221″ passing beyond an outer side edge of each of the two mounting portions 14 in the left-right direction is less than a protruding size W2 of each buckling portion 232″ along the left-right direction. In the testing process of the battery holder 100, if an inspection member improperly touches the outer side edge of the operational portion 221″ and the outer side edge of the mounting portion 14 along the left-right direction simultaneously, the inspection member actuates the operational portion 221″ to deflect inward, which will be stopped by outer side edge of the mounting portion 14, such that the operational portion 221″ cannot further deflect inward, and the distance of the operational portion 221″ deflecting inward is not sufficient to allow the buckling portion 232″ to be released from the locking portion 141, thus preventing the cover 2 from being accidentally released. In other embodiments, W1 may be 0. That is, the outer side edges of the operational portions 221″ are flush with the outer side edges of the mounting portions 14.

In sum, the battery holder 100 according to certain embodiments of the present invention has the following beneficial effects:

(1) The two latching sections 23 deflect to be close toward each other and are simultaneously locked downward to the two locking portions 141, thus limiting the cover 2 from moving in the up-down direction relative to the base body 1. The auxiliary portion 24 is located between the two elastic arms 22, preventing the two elastic arms 22 from excessively deflecting toward each other due to uneven forces, which causes the latching sections 23 to fail to lock to the corresponding locking portions 141, thus ensuring the two latching sections 23 to simultaneously lock to the two locking portions 141, such that the cover 2 may be firmly fixed on the base body 1. The limiting structure of the cover 2 and the latching sections 23 of the cover 2 collectively fix the cover 2 and the base body 1, thus ensuring the firmness and stability of the structure of the battery holder 100. The base portion 21 of the cover 2 and the two elastic arms 22 collectively shield the upper surface of the battery 5. Even in the case of prolonged vibrations, the cover 2 may stop the battery 5, preventing the battery 5 from falling out of the accommodating cavity 13. The surrounding wall 12 shields most of the side surface of the battery 5, and the auxiliary portion 24 shields a portion of the side surface of the battery 5 exposed in the groove 121, such that the children do not easily notice the battery, thus preventing the children from reaching into the accommodating cavity 13 from the top of the accommodating cavity 13 or from the groove 121 and easily taking out the battery 5, and preventing the children from accidentally ingesting the battery 5. The two elastic arms 22 extend along the front-rear direction, and the two latching sections 23 extend along the up-down direction, such that the elastic arms 22 and the latching sections 23 collectively form long moment arm structures with good elasticity for easy mounting and locking of the cover 2. The auxiliary portion 24 partially extends downward to be between the two latching sections 23, and the auxiliary portion 24 has elasticity. In the mounting process of the cover 2, when mounting tolerances exist to cause the two latching sections 23 to excessively deflect, the latching sections 23 may abut against the auxiliary portion 24, which is elastic, and the auxiliary portion 24 deflects together with the latching sections 23 to provide a soft cushioning effect, thus preventing an excessive interference force between the latching sections 23 and the auxiliary portion 24 that damages the latching section 24. The elastic auxiliary portion 24 in turn provides a sufficient force to correct the positions of the two latching sections 23, such that the two latching sections 23 are capable of being normally locked to the two locking portions 141, preventing excessive deformation and damage to the two latching sections 23, ensuring the structural strength of the two latching sections 23, increasing the usage life of the battery holder 100, and reducing the tolerance and dimension requirements of the battery holder 100, which is conducive to reducing the manufacturing cost of the battery holder 100.

(2) The first section 241, the base portion 21 and the two elastic arms 22 collectively shield the upper surface of the battery 5, and the second section 242 enters the groove 121 and shields the side surface of the battery 5 exposed in the groove 121.

The two elastic arms 22 are respectively located at two side edges of the cover 2, and the outer side edges of the two elastic arms 22 are in curved shapes to be close to the inner surface of the surrounding wall 12, thus preventing gaps between the two elastic arms 22 and the surrounding wall 12 from being excessively large to cause the children to insert their fingers therein. In addition, the outer side edges of the two elastic arms 22 do not pass the outer side surface of the surrounding wall 12, thereby ensuring the miniaturization of the volume of the battery holder 100. A width of the first section 241 in an extending direction of the elastic arms 22 gradually decreases, such that a distance between the first section 241 and each elastic arm 22 is always less than a width of the finger of a child. A distance between the second section 242 and each of the two latching sections 23 is less than a width of each latching section 23, such that the children do not easily notice the battery 5, and the children cannot insert their fingers into the accommodating cavity 13, thus preventing the children from reaching into the accommodating cavity 13 from the top of the accommodating cavity 13 or from the groove 121 and easily taking out the battery 5, and preventing the children from accidentally ingesting the battery 5.

(3) A portion of the second section 242 close to the battery 5 is used to shield the side surface of the battery 5, and another portion of the second section 242 is located between the two latching sections 23 to stop the two latching sections 23 from excessively deflecting toward each other. A minimum lateral width of the portion of the second section 242 close to the battery 5 is greater than or equal to a lateral width of the other portion of the second section 242, such that the portion of the second section 242 close to the battery 5 may fully shield the side surface of the battery 5, and the other portion of the second section 242 makes space for the two latching sections 23 to deflect toward each other, thus providing a reserved space. One side of the second section 242 facing the battery 5 forms a guiding curved surface 2421, and the guiding curved surface 2421 guides the second section 242 to cross over the battery 5 above the battery 5 and enters the groove 121, thus preventing the second section 242 from colliding with the battery 5.

(4) An upper surface of the first section 241 is flush with the upper surface of each elastic arm 22, and a lower surface of the second section 242 is flush with the lower surface of each latching section 23 or passes downward beyond the lower surface of each latching section 23, thus ensuring the second section 242 to fully block the two latching sections 23 from excessively deflecting toward each other. The negative elastic sheet 4 is located below the second section 242, and in the up-down direction, a gap exists between the lower surface of the second section 242 and the negative elastic sheet 4, thus preventing the second section 242 and the negative elastic sheet 4 from contacting and colliding.

(5) The base portion 21 and the auxiliary portion 24 are both provided with a plurality of heat dissipation holes 25 running downward therethrough for heat dissipation. Lower surfaces of the base portion 21 and the auxiliary portion 24 are both protrudingly provided with a plurality of reinforcing ribs 26 to reinforce the strength of the base portion 21 and the auxiliary portion 24. A gap exists between a lower surface of each reinforcing rib 26 and the upper surface of the battery 5, thus preventing other reinforcing ribs 26 from interfering with the battery 5 when the cover 2 covers the base body 1, which results in the latching sections 23 of the cover 2 not being able to lock with the base body 1. Each of the two reinforcing ribs 26 closest to the latching sections 23 is further protrudingly provided with a protruding block 27 along the up-down direction. The two protruding blocks 27 are both in contact with the upper surface of the battery 5, thus preventing the battery holder 100 from causing the battery 5 to shake in the accommodating cavity 13 in a vibrating environment. In addition, when the upper surface of the cover 2 is subjected to the collision of an external force, the collision force may be released to the battery 5 through the two protruding blocks 27, and the collision force is further released to the bottom wall 11 of the base body 1 through the battery 5, which finally transfers the collision force to the circuit board, thus preventing the cover 2 from being damaged.

(6) The separation of the cover 2 from the base body 1 requires firstly pressing the two operational portions 221, such that the two buckling portions 232 are released from the two locking portions 141 of the base body 1, and then flipping the cover 2, such that the two rotating portions 212 of the cover 2 are detached from the two pivots 16 of the base body 1, or obliquely pulling the cover 2 out, such that the two limiting blocks H are detached from the two clamping slots F of the base body 1. The step-by-step operations prevent the children from easily taking out the battery 5, thus preventing the children from accidentally ingesting the battery 5. When there is a need to take out the battery 5, it is required to separate the cover 2 and the base body 1 before taking out the battery 5 directly from the groove 121 with fingers.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A battery holder, configured to accommodate a battery, the battery holder comprising:
a base body, having a bottom wall and a surrounding wall extending upward from the bottom wall, wherein the bottom wall and the surrounding wall collectively form an accommodating cavity to accommodate the battery, a side of the surrounding wall is provided with a groove running therethrough, a side wall of the battery is exposed to the groove, and the base body is provided with a locking portion at each of two opposite sides of the groove;
a positive elastic sheet and a negative elastic sheet, respectively accommodated in the base body and electrically connected to the battery, wherein the negative elastic sheet is exposed in the groove; and
a cover, having a base portion, wherein a limiting structure extends from one side of the base portion to be detachably assembled to the base body, two elastic arms and an auxiliary portion located between the two elastic arms extend from another side of the base portion along a front-rear direction, a latching section extends downward from a side of each of the elastic arms away from the base portion, each of the latching sections engages with the corresponding locking portion along an up-down direction, and the auxiliary portion extends downward to be between the two latching sections;
wherein when the battery is installed in the accommodating cavity, the base portion and the two elastic arms collectively shield an upper surface of the battery, the two elastic arms are pressed to move altogether downward, the two latching sections deflect toward each other and lock downward to the two locking portions to fix the cover to the base body along the up-down direction, the auxiliary portion shields the groove, and the auxiliary portion and the surrounding wall collectively shield the side surface of the battery.

2. The battery holder according to claim 1, wherein another side of the base body opposite to the base body is provided with a positioning block, each of two sides of the positioning block is protrudingly provided with a pivot along a left-right direction, in the left-right direction, the two pivots are respectively located at two sides of the positive elastic sheet, the limiting structure comprises a limiting slot concavely provided from the one side of the base portion and two rotating portions protrudingly provided from two sides of the limiting slot respectively, and when the rotating portions of the cover rotate downward around the pivots of the base body such that the cover covers a top portion of the base body, the pivots stop the rotating portions of the cover from moving upward, and the limiting slot of the cover and the positioning block of the base body match with each other to limit the cover in the left-right direction.

3. The battery holder according to claim 2, wherein an inner surface of the surrounding wall is protrudingly provided with a plurality of stopping portions to stop the upper surface of the battery, and a stopping area of a corresponding one of the stopping portions closest to the pivots is greater than a stopping area of each of others of the stopping portions.

4. The battery holder according to claim 3, wherein each of the positive elastic sheet and the negative elastic sheet has a fixing portion fixedly mounted on the base body and at least one contact portion extending from one side of the fixing portion into the accommodating cavity to be electrically connected to the battery, the contact portion of the positive elastic sheet and the contact portion of the negative elastic sheet elastically abut upward against the battery, the contact portion of the positive elastic sheet is higher than the contact portion of the negative elastic sheet, and the corresponding one of the stopping portions closest to the pivots is located above the contact portion of the positive elastic sheet and abuts downward against the battery.

5. The battery holder according to claim 1, wherein two reserved notches are concavely provided downward at locations adjacent to the groove from an upper surface of the surrounding wall, in a left-right direction, the two reserved notches are respectively located at the two sides of the groove and in communication with the groove, the base body is provided with two mounting portions protruding outward at the two sides of the groove, the locking portion is formed by protruding from a side edge of each of the mounting portions away from the groove, one side of each of the two mounting portions closer to the groove is concavely provided with a retaining slot to retain two side edges of the negative elastic sheet, a middle portion of the negative elastic sheet is located in the groove, and the two elastic arms respectively pass through the corresponding reserved notches and are partially located at upper sides of the corresponding mounting portions.

6. The battery holder according to claim 1, wherein one side of each of the elastic arms away from the base portion is provided with an operational portion and a through hole running through the operational portion along the up-down direction, each of the latching sections comprises an extending portion extending downward from a corresponding one of the elastic arms and a buckling portion provided on the extending portion to lock to the locking portion, one of the buckling portion and the locking portion is an engaging slot, the other of the buckling portion and the locking portion is an engaging block, and each of the engaging blocks is exposed in the corresponding one of the through holes in the up-down direction.

7. The battery holder according to claim 1, wherein the base portion and the auxiliary portion are both provided with a plurality of heat dissipation holes running downward therethrough, the battery is exposed in the heat dissipation holes, and a diameter of each of the heat dissipation holes is less than a minimum distance between the two elastic arms.

8. The battery holder according to claim 1, wherein a lower surface of the base portion is protrudingly provided with a plurality of reinforcing ribs, a gap exists between a lower surface of each of the reinforcing ribs and the upper surface of the battery, at least one of the reinforcing ribs closest to the latching sections is further protrudingly provided with a protruding block along the up-down direction, and the protruding block is in contact with the battery.

9. The battery holder according to claim 1, wherein the auxiliary portion is in a cantilever shape and has elasticity, the auxiliary portion comprises a first section extending from the base portion along the front-rear direction and provided at intervals with the two elastic arms, and a second section extending downward from one side of the first section away from the base portion, the first section shields the upper surface of the battery, and the second section enters the groove and shields the side surface of the battery exposed in the groove.

10. The battery holder according to claim 9, wherein when the latching sections and the corresponding locking portions lock together along the up-down direction, a maximum distance between the second section and each of the two latching sections is less than a width of each of the latching sections.

11. The battery holder according to claim 9, wherein a portion of the second section close to the battery is configured to shield the side surface of the battery, another portion of the second section is located between the two latching sections to stop the two latching sections from excessively deflecting toward each other, a minimum lateral width of the portion of the second section close to the battery is greater than or equal to a lateral width of the other portion of the second section, one side of the second section facing the battery forms a guiding curved surface, and the guiding curved surface guides the second section to cross over the battery above the battery and enters the groove.

12. The battery holder according to claim 9, wherein an upper surface of the first section is flush with an upper surface of each of the elastic arms, a lower surface of the second section is flush with a lower surface of each of the latching sections or passes downward beyond the lower surface of each of the latching sections, the negative elastic sheet is located below the second section, and in the up-down direction, a gap exists between the lower surface of the second section and the negative elastic sheet.

13. The battery holder according to claim 9, wherein a distance between the first section and each of the two elastic arms is less than or equal to a distance between the second section and each of the two latching sections.

14. The battery holder according to claim 1, wherein another side of the surrounding wall opposite to the groove is provided with two clamping slots running therethrough, in a left-right direction, the two clamping slots are respectively located at two sides of the positive elastic sheet, the base portion is provided with an abutting portion protruding downward, the abutting portion extends downward to abut the battery, the positive elastic sheet has two contact portions protruding toward the accommodating cavity, the two contact portions are respectively located at two outer sides of extending lines of two side edges of the abutting portion, the limiting structure comprises two limiting blocks protrudingly provided from the one side of the base portion at an interval, and the two limiting blocks and the two clamping slots correspondingly engage and match to limit one side of the cover from moving upward.

15. The battery holder according to claim 1, wherein the two latching sections are both located in the groove to collectively shield the side surface of the battery with the auxiliary portion, the base body is provided with two mounting portions protruding outward at the two sides of the groove, the two locking portions are concavely provided from sides of the two mounting portions facing each other respectively, a buckling portion is provided to protrude from one side of each of the two latching sections away from each other toward a direction away from each other, and the two buckling portions and the two locking portions lock together.

16. A battery holder, configured to accommodate a battery, the battery holder comprising:
a base body, having a bottom wall and a surrounding wall extending upward from the bottom wall, wherein the bottom wall and the surrounding wall collectively form an accommodating cavity to accommodate the battery, a side of the surrounding wall is provided with a groove running therethrough, a side wall of the battery is exposed to the groove, and the base body is provided with a locking portion at each of two opposite sides of the groove;
a positive elastic sheet and a negative elastic sheet, respectively accommodated in the base body and electrically connected to the battery, wherein the negative elastic sheet is exposed in the groove; and
a cover, having a base portion, wherein a limiting structure extends from one side of the base portion to be detachably assembled to the base body, two elastic arms extend from another side of the base portion along a front-rear direction, a latching section extends downward from a side of each of the elastic arms away from the base portion, and each of the latching sections engages with the corresponding locking portion along an up-down direction;
wherein an auxiliary portion is elastic and is provided between the two latching sections, and the auxiliary portion is capable of elastically deflecting to block the two latching sections from excessively deflecting;
wherein when the battery is installed in the accommodating cavity, the base portion and the two elastic arms collectively shield an upper surface of the battery, the two elastic arms are pressed to move altogether downward, the two latching sections deflect toward each other and lock downward to the two locking portions to fix the cover to the base body along the up-down direction, and the auxiliary portion shields a portion of the side surface of the battery exposed in the groove.

17. The battery holder according to claim 16, wherein the auxiliary portion is formed by integrally extending from the cover, the auxiliary portion comprises a first section extending from the base portion along the front-rear direction and located between the two elastic arms and a second section extending downward from the first section and located between the two latching sections, gaps exist between a left side and a right side of the second section and the two latching sections, and the first section and the second section collectively form a cantilever shape, such that the auxiliary portion is capable of elastically deflecting between the two latching sections.

18. The battery holder according to claim 17, wherein a distance between the first section and each of the two elastic arms is less than or equal to a distance between the second section and each of the two latching sections.

19. The battery holder according to claim 17, wherein a width of the second section is less than or equal to a width of the first section, and the width of the second section is less than or equal to a width of each of the latching sections.

20. The battery holder according to claim 17, wherein an extending length of the auxiliary portion along the front-rear direction is equal to a length of each of the elastic arms.
